(19) United States
(12) Patent Application Publication
(10) Pub. No.: US 2025/0189064 A1
(43) Pub. Date: Jun. 12, 2025

(54) METHOD AND DEVICE THAT PREVENT GAS HYDRATE FORMATION AND LIQUEFY GAS HYDRATES AFTER FORMATION

(71) Applicant: Saudi Arabian Oil Company, Dhahran (SA)

(72) Inventors: Mari Hussain Alqahtani, Dhahran (SA); Mustafa Al-Jawad, Alnascra (SA)

(21) Appl. No.: 18/536,493

(22) Filed: Dec. 12, 2023

(51) Int. Cl. F16L 53/35; H05B 1/02

(52) U.S. Cl. CPC F16L 53/35; H05B 1/0247

(57) ABSTRACT

A method for controlling gas hydrate formation comprising the steps of sensing a temperature of a pipeline upstream of a choke valve from a temperature sensor positioned in an array of temperature sensors positioned in a row along a floor of the pipeline, wherein each temperature sensor corresponds to a known position along a length of the pipeline; generating a temperature profile for the pipeline from each temperature sensor as a function of the known position of the temperature sensor; detecting when the temperature is below a temperature setpoint; identifying the known position in the pipeline corresponding to the temperature sensor sensing the temperature below the temperature setpoint; and increasing the temperature of the pipeline at the known position through a heating system selected from the group consisting of a heat material patch, an electrically powered patch, a pipeline casing heating unit, and a threaded electrical heating element.

### TECHNICAL FIELD

Disclosed are systems and methods to control gas hydrates in gas wells. Specifically, disclosed are systems and methods that prevent formation of gas hydrates during startup and remove gas hydrates that have formed inside pipelines.

### BACKGROUND

Gas hydrates form when natural gas gets mixed with water at high velocities (turbulent gas flow) under a pressure of 145 psi or greater, and a temperature of 70 degrees Fahrenheat or less. These conditions are usually met at gas well startup, when pipeline backpressure is greater than the pressure threshold and ambient temperature is less than the temperature threshold. In pipelines, water presence can be related to stagnant water at any point downstream of the wing-valve or associated formation water that gets produced with gas production (2-phase flow). A choke valve in the line, which causes the diameter of a pipeline to be reduced, can lead to increased gas velocity (under constant flow rate condition). In the presence of stagnant water in the pipeline, when choking leads to increased gas velocity gas hydrates can form. Gas hydrates can block or restrict flow during gas well startups.

### SUMMARY

Disclosed are systems and methods to address gas hydrates in gas wells. Specifically, disclosed are systems and methods that prevent formation of gas hydrates during startup and remove gas hydrates that have formed inside pipelines.

In a first aspect, a method for controlling gas hydrate formation is provided. The method includes the steps of sensing a temperature of a pipeline upstream of a choke valve from a temperature sensor positioned in an array of temperature sensors, where the array of temperature sensors is positioned in a row along a floor of the pipeline, where each temperature sensor in the array of temperature sensors corresponds to a known position along a length of the pipeline, generating a temperature profile for the pipeline from the array of temperature sensors, where the temperature profile includes a temperature from each temperature sensor as a function of the known position of the temperature sensor, detecting when the temperature is below a temperature setpoint, identifying the known position in the pipeline corresponding to the temperature sensor sensing the temperature below the temperature setpoint, and increasing the temperature of the pipeline at the known position through a heating system, the heating system selected from the group consisting of a heat material patch, an electrically powered patch, a pipeline casing heating unit, and a threaded electrical heating element.

In certain aspects, each temperature sensor is positioned between 0.05 meters and 1 meter from each other temperature sensor. In certain aspects, the temperature setpoint is the freezing point of water for the pressure in the pipeline. In certain aspects, the temperature setpoint is between 1° C. and 10° C. greater than the freezing point of a water and gas mixture for the pressure in the pipeline. In certain aspects, the method further includes the step of switching off the heating system when the temperature of the pipeline at the known position is greater than the temperature set point. In certain aspects, the heating system is the heat material patch and the step of increasing the temperature of the pipeline includes the steps of installing temporary patches at the known position, where the temporary patches include a heat-capacity material capable of producing heat and increasing the temperature of the pipeline due to heat radiating through the pipeline from the temporary patches. In certain aspects, the heating system is the electrically powered patch and the step of increasing the temperature of the pipeline includes the steps of turning on a power source electrically connected to clamp-on patches installed around the pipeline at the known position, where the clamp-on patches produce heat due to electrical current and increasing the temperature of the pipeline due to heat radiating through the pipeline from the clamp-on patches. In certain aspects, the heating system is the pipeline casing heating unit and the step of increasing the temperature of the pipeline includes the steps of heating a hot oil to a desired temperature through a boiler, feeding the hot oil at the desired temperature through an annulus formed by a casing surrounding the pipeline, and increasing the temperature of the pipeline due to heat radiating through the pipeline from the hot oil in the annulus. In certain aspects, the heating system is the threaded electrical heating element and the step of increasing the temperature of the pipeline includes the steps of turning on a power source electrically connected to an electrical heating element embedded in the walls of the pipeline, increasing the temperature of walls of the pipeline due to the electrical heating element, and increasing the temperature of the pipeline due heat radiating from the walls of the pipeline.

A system for controlling gas hydrate formation, the system includes a pipeline configured for transporting natural gas, a choke valve positioned in the pipeline, a temperature sensor positioned in an array of temperature sensors upstream of the choke valve, where the array of temperature sensors is positioned in a row along a floor of a pipeline, where each temperature sensor in the array of temperature sensors corresponds to a known position along a length of the pipeline, a computer configured to produce a temperature profile, where the temperature profile includes temperature from each temperature sensor as a function of the known position of the temperature sensor, and a heating system positioned upstream of the choke valve, the heating system selected from the group consisting of a heat material patch, a clamp-on electrically powered heat unit, a cased heating system, and a threaded electrical heating element.

In certain aspects, each temperature sensor is positioned between 0.05 meters and 1 meter from each other temperature sensor. In certain aspects, each temperature sensor is a thermocouple. In certain aspects, the heating system is the heat material patch and the heat material patch includes a temporary patch installed at the known position, where the temporary patches includes a heat-capacity material capable of producing heat. In certain aspects, the heating system is the electrically powered patch and the electrically powered patch includes clamp-on patches installed around the pipeline at the known position, and a power source electrically connected to the clamp-on patches, the clamp-on patches configured to produce heat when the power source is turned on. In certain aspects, the heating system is the pipeline casing heating unit and the pipeline casing heating unit includes a heating oil tank configured to store a hot oil, a boiler fluidly connected to the heating oil tank configured to heat the hot oil to a desired temperature, a casing surrounding the pipeline, and an annulus formed in a space between the casing and the pipeline the annulus fluidly connected to the boiler, where hot oil at the desired temperature flows through the annulus. In certain aspects, the heating system is the threaded electrical heating element and the threaded electrical heating element includes an electrical heating element embedded in the walls of the pipeline, and a power source electrically connected to the electrical heating element, the power source configured to turn on the electrical heating element and increase a temperature of walls of the pipeline.

### BRIEF DESCRIPTION OF THE DRAWINGS

These and other features, aspects, and advantages of the scope will become better understood with regard to the following descriptions, claims, and accompanying drawings. It is to be noted, however, that the drawings illustrate only several embodiments and are therefore not to be considered limiting of the scope as it can admit to other equally effective embodiments.

FIGS. 1A-I is a cross-section of a pipeline illustrating formation of gas hydrates upstream of a choke valve.

FIG. 2A-2D is a cross-section of a pipeline illustrating formation of gas hydrates downstream of a choke valve.

FIG. 3A is a top view of a pipeline.

FIG. 3B-3C is a cross-section of a pipeline illustrating an embodiment of gas hydrate control.

FIG. 3D is a graphical representation of a temperature profile of an embodiment of gas hydrate control.

FIG. 4A-4G is an illustration of an embodiment of gas hydrate control using a heat material patches as the heating system.

FIG. 5A-5G is an illustration of an embodiment of gas hydrate control using an electrically powered patch as the heating system.

FIG. 6A-6G is an illustration of an embodiment of gas hydrate control using a pipeline casing heating unit as the heating system.

FIG. 7A-7H is an illustration of an embodiment of gas hydrate control using a threaded electrical heating element as the heating system.

In the accompanying Figures, similar components or features, or both, may have a similar reference label.

### DETAILED DESCRIPTION

While the scope of the apparatus and method will be described with several embodiments, it is understood that one of ordinary skill in the relevant art will appreciate that many examples, variations and alterations to the apparatus and methods described here are within the scope and spirit of the embodiments.

Accordingly, the embodiments described are set forth without any loss of generality, and without imposing limitations, on the embodiments. Those of skill in the art understand that the scope includes all possible combinations and uses of particular features described in the specification.

The systems and methods control gas hydrates in pipelines from gas wells. Controlling gas hydrates assure no production blockage, restrictions or interruption during gas well startup. The systems and methods can remove gas hydrates that have formed in the pipelines and can prevent formation of gas hydrates, in each case by controlling the temperature in the pipelines. Controlling the temperature can result in maintaining the temperature at greater than the gas hydrate temperature threshold. Removing gas hydrates can occur by melting the gas hydrates. The temperature in the pipeline is controlled utilizing heat, where the introduction of heat can control the temperature to greater than the temperature at which gas hydrates form. Advantageously, associate a temperature sensor with a position in the pipeline enables accurate identification of hydrate location and hydrate size. Advantageously, controlling gas hydrates guarantees continuous natural gas flow in a pipeline.

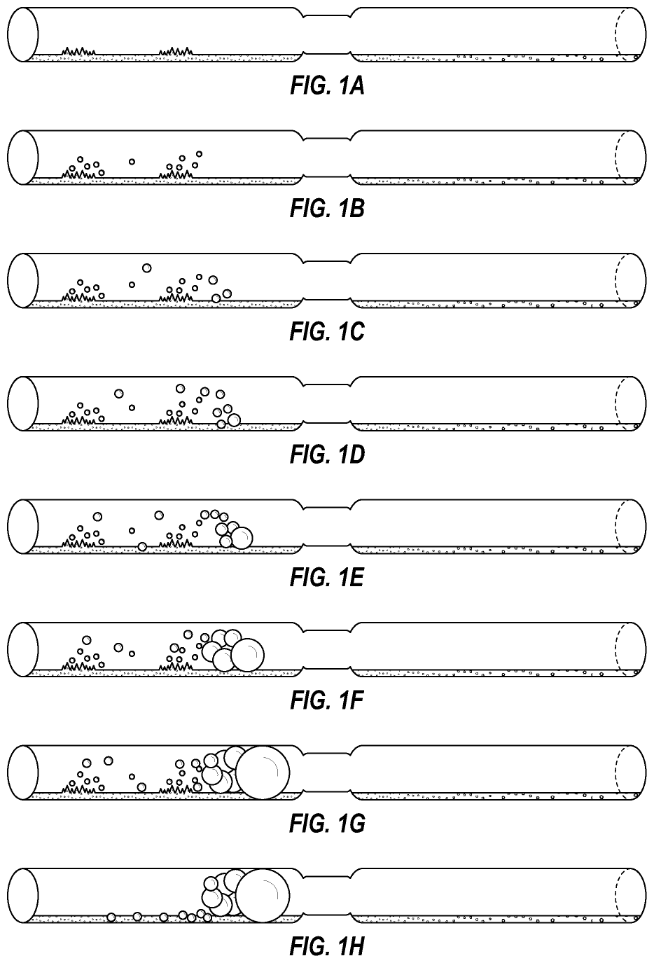

As used throughout, “gas hydrate” or “gas ice” refers to solid particles formed from the mixing of water and natural gas. Four elements are required for gas hydrate formation: (i) gas velocities which result in turbulent gas flow, (ii) presence of water, (iii) pressure greater than or equal to 145 psi (9.9974 bar), and (iv) temperature less than or equal to 70° F. (21.1° C.). Formation of gas hydrates upstream of a choke valve can be understood with reference to FIGS. 1A-I. FIG. 1A shows stagnant water in the bottom portion of the pipeline. It is assumed that the temperature and pressure are at gas hydrate conditions because the pipeline is transporting natural gas, thus three of the elements for formation of gas hydrate are met. The natural gas flowing in the pipeline can be at velocity sufficient to produce turbulent gas flow. In at least one embodiment, turbulent flow velocity can be caused by a valve (not shown), such as a wing valve, in the pipeline. One of skill in the art will appreciate that any other restriction in the pipeline that causes reduction in the pipeline inner diameter can create turbulent flow, with the smaller the inner diameter the more pronounced the turbulent flow. Turbulent flow will result in the mixing of the gas and water at the interface, where water ripples and mist are created as illustrated in FIGS. 1A and 1B. As the water and natural gas are mixed, small gas hydrate particles start to form as illustrated in FIG. 1C. As shown in FIG. 1D, because gas hydrates are denser than gas, they start collecting out of the gas phase and accumulate at the bottom of the pipeline. The accumulation will accelerate the production of gas hydrates because once the gas hydrate mass reaches a significant size, the gas hydrate mass itself can cause a choking effect that further increases the gas velocity leading to more and rapid gas hydrate formation as shown in FIGS. 1E-1F. Eventually, the accumulation of gas hydrates will gain enough mass and volume to completely block gas flow, FIG. 1H, turbulent mixing will stop, and no further gas hydrates will form in the flowline, FIG. 1I.

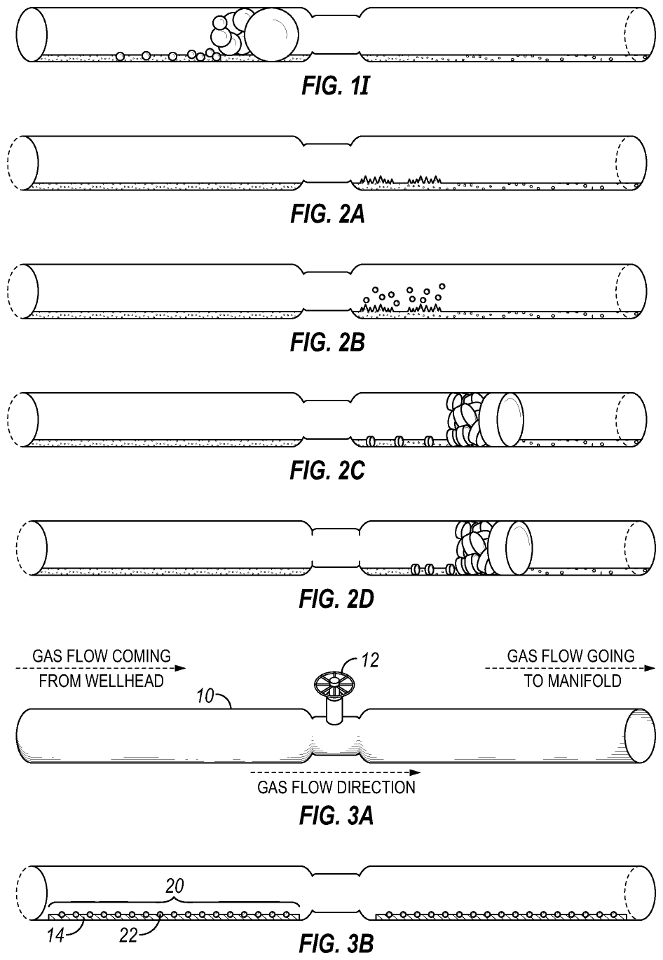

Alternately, as described with reference to FIGS. 2A-2D, gas hydrates can form downstream of the choke valve. In FIG. 2A-2D, the choke valve produces the turbulent flow causing the gas and water to mix at the interface of the stagnant water as shown in FIGS. 2A and 2B. In FIG. 2C, a pipeline where the gas hydrates have accumulated to the point of blocking the gas flow is shown. In FIG. 2D, the pipeline at the point where turbulent flow and mixing have stopped is shown.

As used throughout, “floor” means the lowest elevation interior point in a pipeline.

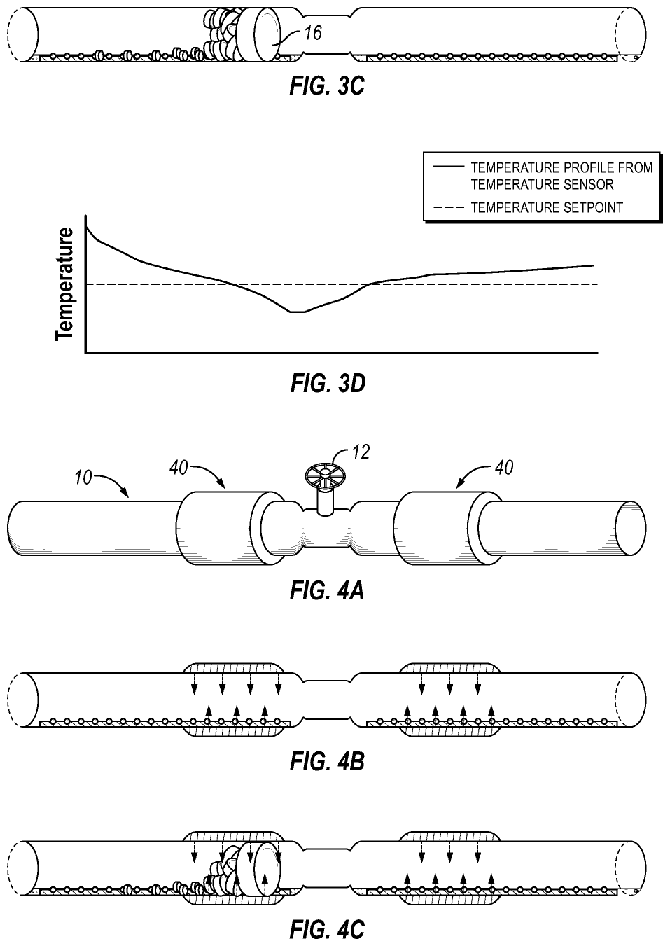

Referring to FIGS. 3A-3D, an embodiment of the method of controlling gas hydrates can be understood. Pipeline 10 carries natural gas from the wellhead to the manifold. Pipeline 10 can be any size and type of pipeline suitable for use in transporting natural gas from a wellhead of a gas well. Pipeline 10 contains choke valve 12. Choke valve 12 can be any type of choke valve that can control the flow rate of wells. Choke valves can be the in a horizontal pipeline, such as pipelines lines laid down horizontally on the ground, can be a source of gas hydrates due to the ambient temperatures of the pipelines and the accumulated water on the “floor” of the pipeline. Choke valves in vertical pipelines, such as those that are part of the wellhead do not have the same risk of forming gas hydrates. A horizontal gas pipeline can include one or more choke valve.

Array of temperature sensors 20 can be installed in floor 14 of pipeline 10. Array of temperature sensors 20 can be comprised of a plurality of temperatures sensors 22 arranged in a row. Each temperature sensor 22 can be any type of instrument capable of detecting, measuring and transmitting temperature of a liquid or a gas. Temperature sensors 22 can be instruments capable of providing additional operating conditions, such as maximum temperature, minimum temperature, pressure, fluid type and flow rate. In at least one embodiment, temperature sensor 22 can be a thermocouple. Array of sensors 20 is positioned on floor 14 pipeline 10. Each temperature sensor 22 can continuously transmit temperature data from the interior of pipeline 10. The distance between temperature sensors 22 in array of sensors 20 can be between 0.05 meters and 1.5 meters, alternately between 0.05 meters and 1 meter, alternately between 0.05 meters and 0.5 meters, alternately between 0.5 meters and 1 meter, and alternately between 0.05 meters and 0.1 meters. In at least one embodiment, the distance between temperature sensors 22 is between 0.05 meters and 1 meter. One of skill in the art will appreciate that the optimum distance between temperature sensors 22 can be based on technical parameters. Other technical parameters can also be considered in determining the number of temperature sensors and the distance between each temperature sensors. Technical parameters can include the water content, restrictions in the pipeline (for example, orifices in the pipeline), changes in the pipeline elevation (for example, where the pipeline is not horizontal), changes in pipeline inner diameter, and combinations of the same. Depending on the values of these technical parameters more temperature sensors may be required. Additionally, the temperature sensors can be uniformly distributed in the array of temperature sensors or can be non-uniformly distributed in the array of temperature sensors. In at least one embodiment, the temperature sensors can be positioned closer to each other nearer to restrictions in the pipeline or changes in pipeline diameter and can be positioned farther from each other in horizontal runs of the pipeline. The greater the number of temperature sensors, the better resolution of the temperature profile, which can produce more accurate response of the heating system. However, budget constraints may limit the number of temperature sensors.

Each temperature sensor 22 is associated with a known position along the length of pipeline 10. Temperature sensors do not have to be equally spaced, as long as their positions are known. By associating each temperature sensor 22 with a known position along the length of pipeline 10, the gas hydrate control system can determine a temperature for any given location in pipeline 10. Because each temperature sensor 22 is associated with a known position in pipeline 10, the location of areas of concern for gas hydrate formation and the dimensions can be detected accurately.

Each temperature sensor 22 continuously transmits a temperature. The temperature data received from temperature sensors 22 can be used to generate a temperature profile for pipeline 10. The temperature profile is a graphical representation of the temperature at each position along pipeline 10. FIG. 3D depicts a temperature profile for the embodiment of the pipeline illustrated in FIG. 3C, where gas hydrates 16 have formed upstream of choke valve 12. The temperature profile enables accurate detection of an area of concern for gas hydrate formation and the dimensions for such formation. The temperature profile provides a graphical representation that can be used to determine areas of concern based on the real time temperature compared to the gas hydrate threshold or a temperature setpoint.

The gas hydrate threshold is the temperature at which gas hydrate formation is likely to occur or has occurred. The temperature setpoint can be a designated point for a given system and can be based on a known gas hydrate threshold or can be based on conditions in the pipeline. The temperature setpoint can be the gas hydrate threshold. Alternately, the temperature setpoint can be the freezing point of water at the pressure in the pipeline, alternately between 1° C. and 20° C. greater than the freezing point of the water and gas mixture at the pressure in the pipeline, alternately between 1° C. and 10° C. greater than the freezing point of the water and gas mixture at the pressure in the pipeline, alternately between 5° C. and 20° C. greater than the freezing point of the water and gas mixture at the pressure in the pipeline, alternately between 5° C. and 10° C. greater than the freezing point of the water and gas mixture at the pressure in the pipeline, and alternately between 10° C. and 20° C. greater than the freezing point of the water and gas mixture at the pressure in the pipeline. In at least one embodiment, the temperature setpoint can be the freezing point of the water and gas mixture at the pressure in the pipeline. The temperature setpoint can be selected to reflect the operating conditions in the pipeline to predict gas hydrate formation. Gas hydrates are never desirable to form, no matter how small in size. Large gas hydrates can cause restriction in flow, and sometimes total blockage of flow, and small gas hydrates will move with the flow and cause erosion, and consequently corrosion, in the pipeline interior because gas hydrates are crystals and have sharp edges that can create cuts and dents in metal and interior coating. Prevention of gas hydrate formation can be avoided in its entirety.

The temperature profile can be observed for temperatures that fall below the temperature setpoint. The observation can be done by human, such as through sight on a monitor, or can be automated, such as through an alarm in a control module. When a temperature in pipeline 10 below the temperature setpoint is detected, the position of the temperature sensor 22 transmitting the temperature is determined and a known position in pipeline 10 is identified. Because each temperature sensor 22 is associated with a known position, the observation of the temperature profile improves accuracy of the location of gas hydrates or potential for gas hydrate formation.

A temperature reading in the temperature profile below the temperature profile indicates a location where gas hydrate formation has occurred, is occurring, or is likely to occur. In the embodiment of gas hydrate control depicted in FIG. 3C, gas hydrate formation has occurred such that gas hydrates 16 are present in pipeline 10, as depicted in FIG. 3C. One of skill in the art can appreciate that a temperature profile of FIG. 1A and FIG. 1B could also be below the temperature setpoint indicating gas hydrate formation is occurring or is likely to occur.

To control gas hydrate formation in the pipeline, the temperature in the pipeline can be increased through a heating system. Advantageously, the systems and methods to control gas hydrates described herein increase the temperature in the pipeline at the known position, where the temperature sensor senses a temperature below the temperature setpoint, thus reducing energy expenditure and creating a targeted approach to gas hydrate control. Heating the entire pipeline to a temperature greater than the temperature setpoint would take a significant amount of time whereas heating only at the known position takes less time and reduces the time to melt gas hydrates or prevent gas hydrate formation. The heat provided by the heating system can assure that the fluid temperature in the pipeline does not fall below the temperature setpoint, thus assuring that gas hydrates do not form or those that have formed melt. The heat provided by the heating system can maintain melt gas hydrates that have formed until no flow restriction or blockage exists. The heating system can be any type of heating system capable of providing targeted heat to an area of a pipeline. Examples of the heating system suitable for use include a heat material patch, an electrically powered patch, a pipeline casing heating unit, and a threaded electrical heating element. Alternately, examples of the heating system suitable for use include a pipeline casing heating unit and a threaded electrical heating element. One of skill in the art will appreciate that each system can be used prior to formation of gas hydrates or after formation of gas hydrates depending on the temperature setpoint.

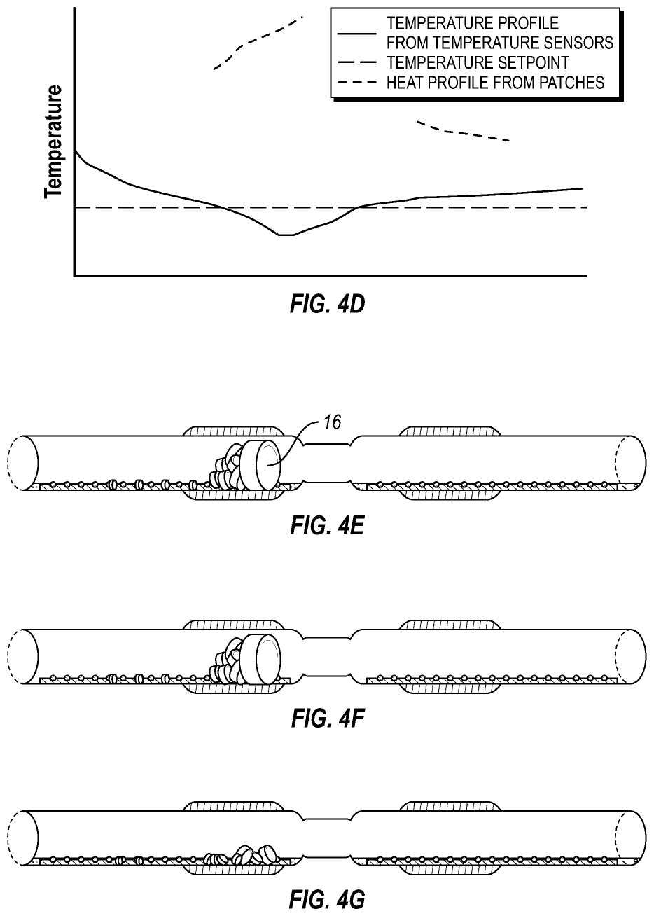

Referring to FIG. 4A-4G, the heat material patch heating system is described. Temporary patches 40 and can be placed on the exterior of pipeline 10. Temporary patches can be placed upstream and downstream of choke valve 12, alternately only upstream (not shown), and alternately only downstream (not shown). Temporary patches 40 can be any type of heat-capacity material capable of reaching temperatures that allow the interior of the pipeline to reach temperatures greater than the temperature setpoint, as shown in FIG. 4D. Temporary patches 40 can be reusable patches or one-time use patches. Temporary patches 40 can be installed directly on pipeline 10 at the known position. Temporary patches 40 operate by radiating heat to the outer circumference of the pipeline as shown in FIG. 4B. As heat dissipates towards the inner contents of the pipeline, the temperature in the pipeline will increase toward the desired temperature greater than the temperature setpoint causing the gas hydrates to melt away, as shown in FIGS. 4C, 4E-4G. Advantageously, the heat material patch heating system can be installed as needed allowing an agile response at the known position. Advantageously, the heat material patch heating system can be used for moderate conditions where the temperature profile is not severely below the freezing point.

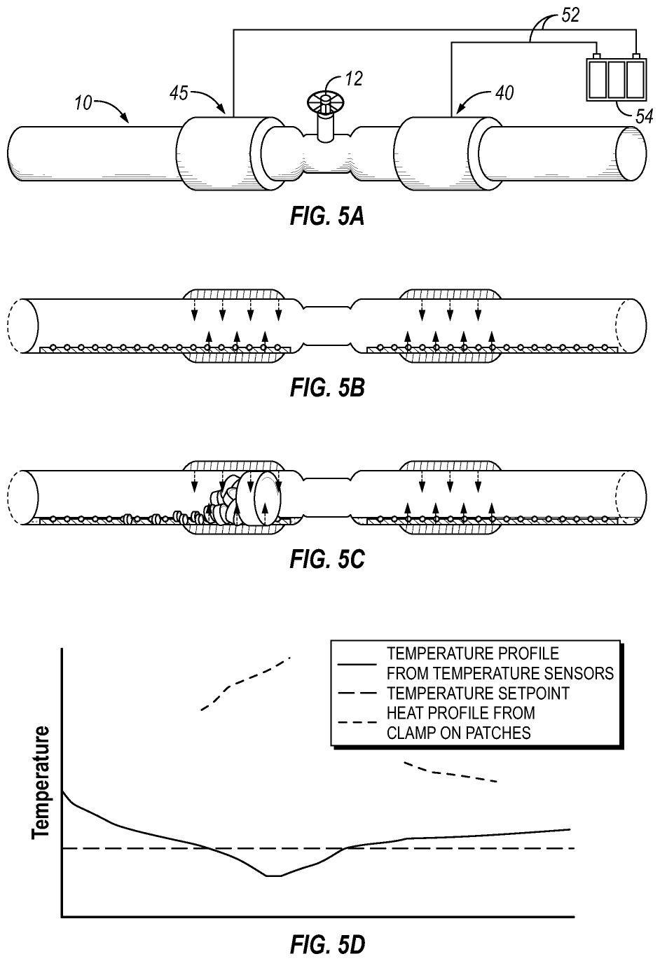

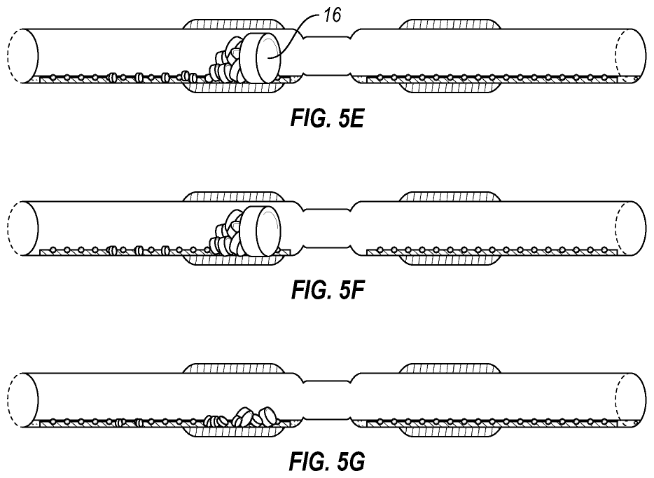

Referring to FIG. 5A-5G, the electrically powered patch heating system is described. Clamp-on patches 50 can be placed upstream and downstream of coke valve 12, alternately only upstream (not shown), and alternately only downstream (not shown). Clamp-on patches 50 can be any type of electrically powered patches that fit around a pipeline and are removable. Examples of clamp-on patches can include electrical heating blankets, electrical patches, and combinations of the same. Clamp-on patches 50 are connected through electrical lines 52 to power source 54. Examples of power source 54 can include electricity grid, batteries, solar power, generator, and combinations of the same. Clamp-on patches 50 can be installed directly on pipeline 10 at the known position. Clamp-on patches 50 are powered to produce heat due to electrical current to the desired temperature based on the temperature profile observed, as shown in FIG. 5D. Heat radiates from clamp-on patches 50 through pipeline 10 to increase the temperature of the inner contents of the pipeline, as shown in FIGS. 5B and 5C. As the temperature of the interior of pipeline 10 increases the temperature will equalize to the desired temperature greater than the gas hydrate threshold causing the gas hydrates to melt away, as shown in FIGS. 5E-5G. Advantageously, the electrically powered patch heating system is reusable and can be installed as needed at the known position. Advantageously, the electrically powered patch heating system can allow for dynamic control of the interior temperature of the pipeline by controlling the amount of power provided to each clamp-on patch.

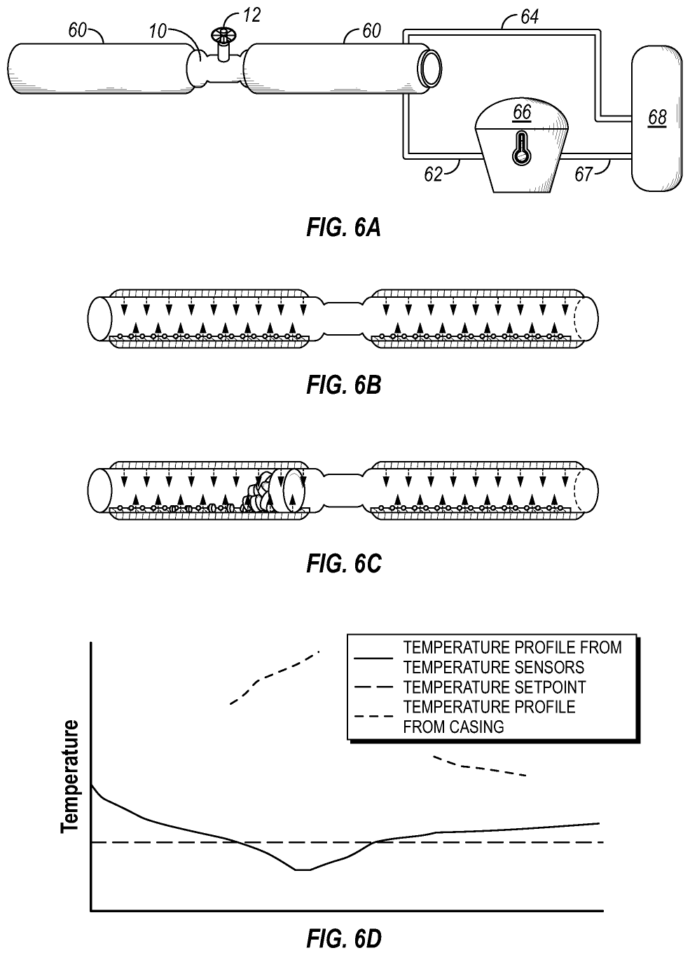

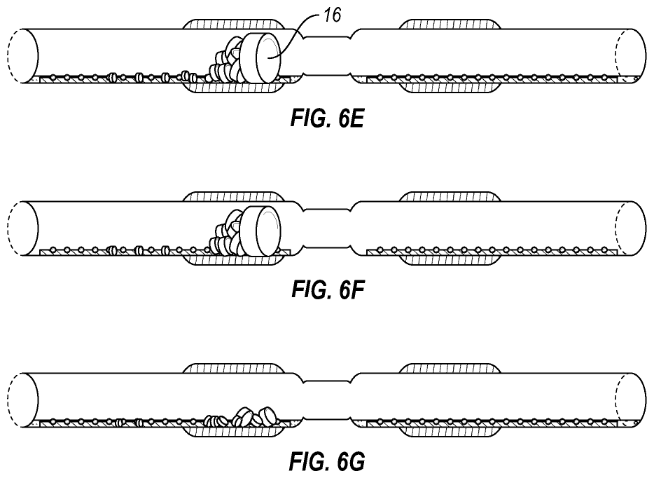

Referring to FIGS. 6A-6G, the pipeline casing heating unit heating system is described. As shown in FIG. 6A, casing 60 encapsulates pipeline 10 creating an annulus 61 between casing 60 and pipeline 10. Casing 60 is permanently installed around pipeline 10. Hot oil gets circulated through annulus 61 as the source of heat for increasing the temperature of the inner contents of pipeline 10. Heating oil tank 68 stores the hot oil until a temperature sensor registers a temperature below the temperature set point. The hot oil is then transferred to boiler 66 boiler feed line 67. The temperature of the hot oil is increased in boiler 66 until it reaches the desired temperature for heat transfer to the inner contents of the pipeline. The hot oil at the desired temperature the flows through hot oil feed line 62 to annulus 61. The hot oil can flow from annulus 61 back to heating oil tank 68 through oil transfer line 64. The system can be continuous or can be batch. The boiler system can include pumps, valves, and instrumentation to keep the hot oil flowing. Heat radiates from the hot oil in annulus 61 through pipeline 10 to the inner contents, as shown in FIGS. 6B and 6C. The temperature of the hot oil can be determined based on the temperature profile and the needed heat transfer as shown in FIG. 6D. As the temperature of the interior of pipeline 10 the temperature will equalize to the desired temperature greater than the gas hydrate threshold causing gas hydrates to melt away, as shown in FIGS. 6E-6G. The pipeline casing heating unit heats the entire length of the installed casing regardless of the position of the gas hydrates. Advantageously, the pipeline casing heating unit is permanently installed allowing for instant response to an observed temperature profile below the temperature setpoint. Advantageously, the pipeline casing heating unit heating system allows dynamically changing the heating profile in response to the live temperature profile values. In at least one embodiment, one or more boilers can be used set to increase the temperature of hot oil to different temperatures to allow for different temperature in the annulus. Additionally, the casing can be segmented and connected to different boilers allowing for different sections of the casing to experience different temperatures.

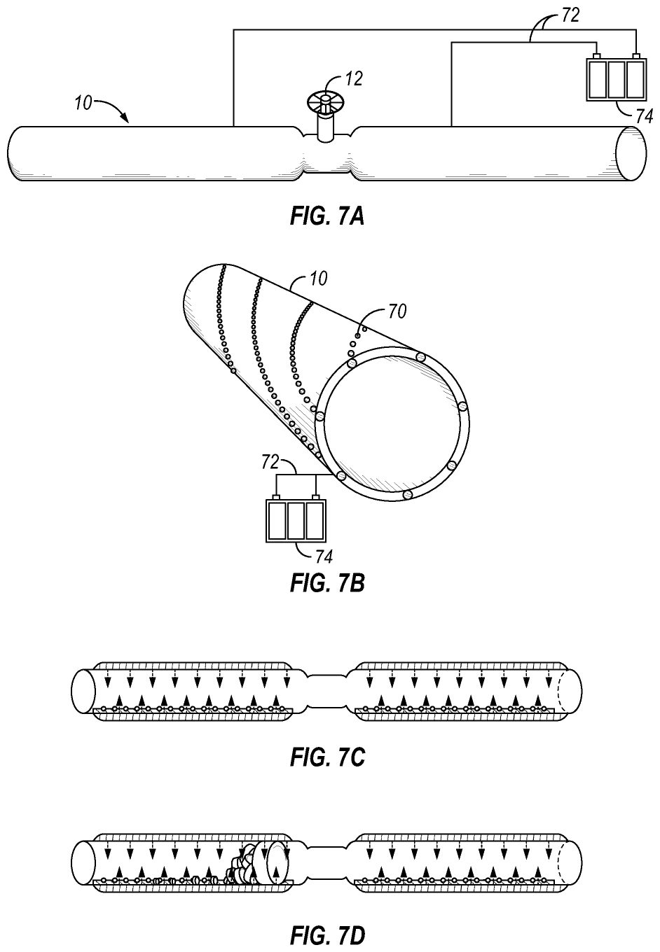

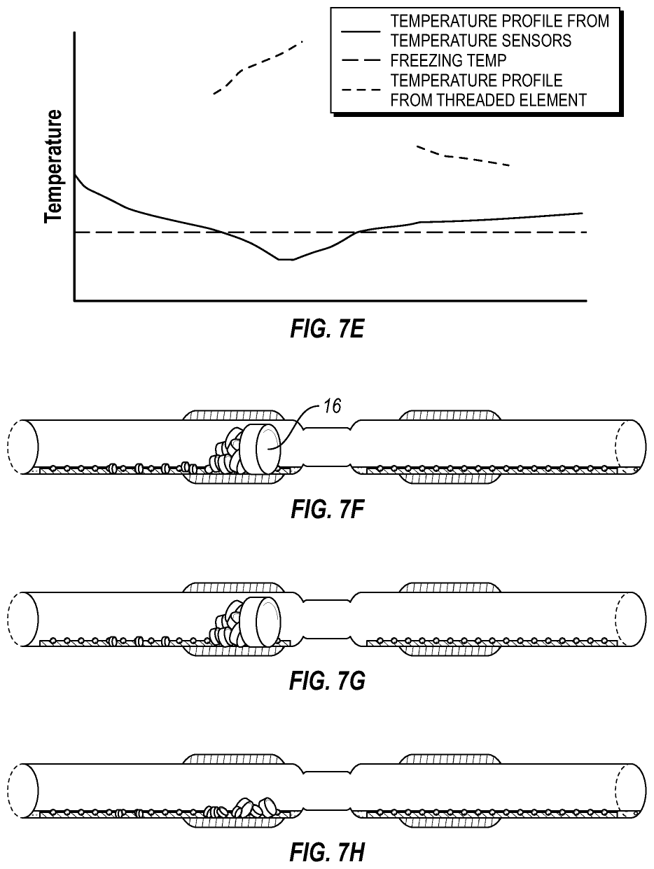

Referring to FIG. 7A-7H, the threaded electrical heating element heating system is described. Electrical heating element 70 can be threaded within the thickness of the pipe walls of pipeline 10, as shown in FIGS. 7A and 7B. Electrical heating element 70 can be any type of electrical element capable of being embedded in the walls of a pipeline. Electrical heating element 70 is connected to power source 74 through wires 72. When a temperature in the temperature profile below the temperature setpoint is detected, power source 74 can be turned on which provides power to electrical heating element 70 and increases the temperature of the walls of pipeline 10. The temperature of electrical heating element 70 can be based on the temperature profile, as shown in FIG. 7E. As the temperature is increased, the heat radiates from the pipeline walls into the contents of the pipeline increasing the temperature of the interior of pipeline 10, as shown in FIGS. 7C and 7D. The increased temperature in the interior of pipeline 10 will cause the temperature to equalize at the desired temperature greater than the gas hydrate threshold causing gas hydrates to melt away, as shown in FIGS. 7F-7H. Advantageously, the threaded electrical heating element heating system is permanently installed allowing for instant response to observations of temperatures in the temperature profile below the temperature setpoint. Advantageously, the threaded electrical heating element heating system can dynamically change the temperature in the interior of the pipeline based on real time observation of the temperature profile.

The heating systems can be fully automated or semi-automated. When fully automated, a computer can be used to determine if heat should be applied based on the temperature profile relative to the temperature setpoint. The computer then can determine when the heat should be stopped based on the temperature profile reading temperatures greater than the temperature setpoint. In a semi-automated system, the control system would act as an advisor to the operator, who would get a recommendation to turn the heat on at a desirable location based on the temperature profile.

One of skill in the art will appreciate that while the methods and systems to provide gas hydrate control make reference to one temperature sensor, more than one temperature sensor can indicate a temperature below the temperature setpoint at a given time. Such temperature sensors can be adjacent to each other or could be at multiple spots along the pipeline. Advantageously, the systems and methods for gas hydrate control enable control of gas hydrates along a pipeline in multiple locations at one time.

Advantageously, the methods and systems for gas hydrate control are in the absence of additives or chemical means to prevent or eliminate gas hydrates, including the use of thermodynamic hydrate inhibitors or solvents. The methods and systems for gas hydrate control are in the absence of measuring pressure in the pipeline. The methods and systems for gas hydrate control are in the absence of measuring water content or a water content sensor.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

There various elements described can be used in combination with all other elements described here unless otherwise indicated.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed here as from about one particular value to about another particular value and are inclusive unless otherwise indicated. When such a range is expressed, it is to be understood that another embodiment is from the one particular value to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these references contradict the statements made here.

As used here and in the appended claims, the words “comprise,” “has,” and “include” and all grammatical variations thereof are each intended to have an open, non-limiting meaning that does not exclude additional elements or steps.

That which is claimed is:

1. A method for controlling gas hydrate formation, the method comprising the steps of:
sensing a temperature of a pipeline upstream of a choke valve from a temperature sensor positioned in an array of temperature sensors, where the array of temperature sensors is positioned in a row along a floor of the pipeline, wherein each temperature sensor in the array of temperature sensors corresponds to a known position along a length of the pipeline;
generating a temperature profile for the pipeline from the array of temperature sensors, where the temperature profile comprises temperature from each temperature sensor as a function of the known position of the temperature sensor;
detecting when the temperature is below a temperature setpoint;
identifying the known position in the pipeline corresponding to the temperature sensor sensing the temperature below the temperature setpoint; and
increasing the temperature of the pipeline at the known position through a heating system, the heating system selected from the group consisting of a heat material patch, an electrically powered patch, a pipeline casing heating unit, and a threaded electrical heating element.

2. The method of claim 1, wherein each temperature sensor is positioned between 0.05 meters and 1 meter from each other temperature sensor.

3. The method of claim 1, wherein the temperature setpoint is the freezing point of water for the pressure in the pipeline.

4. The method of claim 1, wherein the temperature setpoint is between 1° C. and 10° C. greater than the freezing point of a water and gas mixture for the pressure in the pipeline.

5. The method of claim 1 further comprising the step of switching off the heating system when the temperature of the pipeline at the known position is greater than the temperature set point.

6. The method of claim 1, where the heating system is the heat material patch and the step of increasing the temperature of the pipeline comprises the steps of:
installing temporary patches at the known position, where the temporary patches comprises a heat-capacity material capable of producing heat; and
increasing the temperature of the pipeline due to heat radiating through the pipeline from the temporary patches.

7. The method of claim 1, where the heating system is the electrically powered patch and the step of increasing the temperature of the pipeline comprises the steps of:
turning on a power source electrically connected to clamp-on patches installed around the pipeline at the known position, where the clamp-on patches produce heat due to electrical current; and
increasing the temperature of the pipeline due to heat radiating through the pipeline from the clamp-on patches.

8. The method of claim 1, where the heating system is the pipeline casing heating unit and the step of increasing the temperature of the pipeline comprises the steps of:
heating a hot oil to a desired temperature through a boiler;
feeding the hot oil at the desired temperature through an annulus formed by a casing surrounding the pipeline; and
increasing the temperature of the pipeline due to heat radiating through the pipeline from the hot oil in the annulus.

9. The method of claim 1, where the heating system is the threaded electrical heating element and the step of increasing the temperature of the pipeline comprises the steps of:
turning on a power source electrically connected to an electrical heating element embedded in the walls of the pipeline;
increasing the temperature of walls of the pipeline due to the electrical heating element; and
increasing the temperature of the pipeline due heat radiating from the walls of the pipeline.

10. A system for controlling gas hydrate formation, the system comprising:
a pipeline configured for transporting natural gas;
a choke valve positioned in the pipeline;
a temperature sensor positioned in an array of temperature sensors upstream of the choke valve, where the array of temperature sensors is positioned in a row along a floor of a pipeline, wherein each temperature sensor in the array of temperature sensors corresponds to a known position along a length of the pipeline;
a computer configured to produce a temperature profile, where the temperature profile comprises temperature from each temperature sensor as a function of the known position of the temperature sensor; and
a heating system positioned upstream of the choke valve, the heating system selected from the group consisting of a heat material patch, a clamp-on electrically powered heat unit, a cased heating system, and a threaded electrical heating element.

11. The system of claim 10, wherein each temperature sensor is positioned between 0.5 meter and 1 meter from each other temperature sensor.

12. The system of claim 10, where the temperature sensors are a thermocouple.

13. The system of claim 10, where the heating system is the heat material patch and the heat material patch comprises a temporary patch installed at the known position, where the temporary patches comprises a heat-capacity material capable of producing heat.

14. The system of claim 10, where the heating system is the electrically powered patch and the electrically powered patch comprises:
clamp-on patches installed around the pipeline at the known position; and
a power source electrically connected to the clamp-on patches, the clamp-on patches configured to produce heat when the power source is turned on.

15. The system of claim 10, where the heating system is the pipeline casing heating unit and the pipeline casing heating unit comprises:
a heating oil tank configured to store a hot oil;
a boiler fluidly connected to the heating oil tank configured to heat the hot oil to a desired temperature;
a casing surrounding the pipeline; and
an annulus formed in a space between the casing and the pipeline the annulus fluidly connected to the boiler, where hot oil at the desired temperature flows through the annulus.

16. The system of claim 10, where the heating system is the threaded electrical heating element and the threaded electrical heating element comprises:
an electrical heating element embedded in the walls of the pipeline; and
a power source electrically connected to the electrical heating element, the power source configured to turn on the electrical heating element and increase a temperature of walls of the pipeline.
